(19) United States
(12) Patent Application Publication
(10) Pub. No.: US 2026/0260382 A1
(43) Pub. Date: Sep. 3, 2026

(54) IMAGE PROCESSING METHOD, APPARATUS AND DEVICE

(71) Applicant: Beijing Zitiao Network Technology Co., Ltd., Beijing (CN)

(72) Inventor: Hongwen ZHOU, Beijing (CN)

(21) Appl. No.: 19/553,126

(22) Filed: Feb. 27, 2026

(30) Foreign Application Priority Data
Feb. 28, 2025 (CN) 202510240046.9

(51) Int. Cl. G06T 7/90; G06T 5/20; G06T 5/40; G06T 5/50; G06T 7/11

(52) U.S. Cl. CPC G06T 7/90; G06T 5/20; G06T 5/40; G06T 5/50; G06T 7/11; G06T 2207/20221; G06T 2207/30201

(57) ABSTRACT

Provided are an image processing method, apparatus, and a device. A first mask image and a second mask image that correspond to a first image are obtained, the first mask image being used to indicate a first skin area of a target object in the first image, and the second mask image being used to indicate a second skin area of the target object in the first image; a color adjustment parameter is obtained on the basis of the first mask image, the second mask image, and the first image; and a color of the second skin area of the target object in the first image is adjusted according to the color adjustment parameter, to obtain a second image in which the color of the second skin area of the target object matches a color of the first skin area of the target object.

### CROSS REFERENCE TO RELATED APPLICATIONS

This present application claims the benefit of priority to Chinese Application No. 202510240046.9, filed on Feb. 28, 2025, the entire contents of which are incorporated herein by reference.

### TECHNICAL FIELD

The present application relates to the technical field of media processing, and in particular, to an image processing method, apparatus, and a device.

### BACKGROUND

At a time when requirements for image processing are increasing, various algorithms and tools are widely used to improve image quality, and in particular, skin beautification of a main object (such as a person or an animal) in an image has become a concern for many users.

Taking the main object in the image being a person as an example, in many cases, there will be differences in the skin of different parts of the person in the image, and such differences are not expected to be seen by the users. In other words, an ideal presentation effect of the person in the image that the users want to obtain should not include such differences.

### SUMMARY

In view of this, embodiments of the present application provide an image processing method, apparatus, and a device.

The technical solutions provided by the embodiments of the present application are as follows:

In a first aspect of the present application, an image processing method is provided, including:
obtaining a first mask image and a second mask image corresponding to a first image, the first mask image being used to indicate a first skin area of a target object in the first image, and the second mask image being used to indicate a second skin area of the target object in the first image;
obtaining a color adjustment parameter based on the first mask image, the second mask image and the first image;
adjusting a color of the second skin area of the target object in the first image according to the color adjustment parameter to obtain a second image, a color of the second skin area of the target object in the second image matching a color of the first skin area of the target object.

In some implementations, the color adjustment parameter includes a brightness adjustment curve and/or a hue adjustment parameter, the brightness adjustment curve is used to adjust brightness of the second skin area to match brightness of the first skin area, and the hue adjustment parameter is used to adjust a hue of the second skin area to match a hue of the first skin area.

As an example, the obtaining the brightness adjustment curve based on the first mask image, the second mask image and the first image includes:
obtaining a first brightness mean value of the first skin area based on the first mask image and the first image, and obtaining a brightness distribution histogram and a second brightness mean value of the second skin area based on the second mask image and the first image;
obtaining the brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

As another example, the brightness adjustment curve is a power function curve, and the obtaining the brightness adjustment curve based on a difference between the first brightness mean value and the second brightness mean value, the brightness distribution histogram, and an initial adjustment curve includes:
obtaining the initial adjustment curve based on the difference between the first brightness mean value and the second brightness mean value;
adjusting the brightness distribution histogram based on the initial adjustment curve to obtain a third brightness mean value corresponding to the second skin area;
using the initial adjustment curve as the brightness adjustment curve if a difference between the first brightness mean value and the third brightness mean value satisfies an iteration stop condition;
if the difference between the first brightness mean value and the third brightness mean value does not satisfy the iteration stop condition, updating a parameter of the initial adjustment curve according to the difference between the first brightness mean value and the third brightness mean value, and returning to the step of adjusting the brightness distribution histogram based on the initial adjustment curve to obtain the third brightness mean value corresponding to the second skin area and subsequent steps.

In some implementations, the adjusting the color of the second skin area of the target object in the first image according to the color adjustment parameter to obtain the second image includes:
processing a color of each pixel point in the first image through the brightness adjustment curve to obtain a third image;
updating a corresponding pixel point in the first image with a color of a pixel point in the second skin area in the third image, and using an updated first image as the second image.

In some implementations, the obtaining the hue adjustment parameter based on the first mask image, the second mask image and the first image includes:
obtaining an average color of the first skin area based on the first mask image and the first image.

As an example, the adjusting the color of the second skin area of the target object in the first image according to the color adjustment parameter to obtain the second image includes:
adjusting a hue of the second skin area in the first image according to the average color of the first skin area to obtain the second image, the hue of the second skin area in the second image matching the hue of the first skin area.

In some implementations, the obtaining the first mask image and the second mask image corresponding to the first image includes:
obtaining a third mask image according to the first image and a skin segmentation algorithm, the third mask image being used to indicate a third skin area of the target object in the first image, and the third skin area including the first skin area and the second skin area;
obtaining the first mask image based on a face segmentation algorithm and the first image;
obtaining the second mask image based on the third mask image and the first mask image.

As an example, the obtaining the second mask image based on the third mask image and the first mask image includes:
eliminating the first skin area indicated by the first mask image from the third skin area indicated by the third mask image to obtain a fourth mask image, the fourth mask image being used to indicate the second skin area;
obtaining a fifth mask image according to the second skin area indicated by the fourth mask image and the first skin area indicated by the first mask image, the fifth mask image being used to indicate a connection area between the first skin area and the second skin area;
performing blurring processing on the connection area indicated by the fifth mask image to obtain a sixth mask image;
fusing the sixth mask image with the fourth mask image to obtain the second mask image.

In a second aspect of the present application, an image processing apparatus is further provided, including:
a segmentation unit, configured to obtain a first mask image and a second mask image corresponding to a first image, the first mask image being used to indicate a first skin area of a target object in the first image, and the second mask image being used to indicate a second skin area of the target object in the first image;
a calculation unit, configured to obtain a color adjustment parameter based on the first mask image, the second mask image and the first image;
an adjustment unit, configured to adjust a color of the second skin area of the target object in the first image according to the color adjustment parameter to obtain a second image, a color of the second skin area of the target object in the second image matching a color of the first skin area of the target object.

In some implementations, the color adjustment parameter includes a brightness adjustment curve and/or a hue adjustment parameter, the brightness adjustment curve is used to adjust brightness of the second skin area to match brightness of the first skin area, and the hue adjustment parameter is used to adjust a hue of the second skin area to match a hue of the first skin area.

As an example, the calculation unit includes:
a first calculation subunit, configured to obtain a first brightness mean value of the first skin area based on the first mask image and the first image, and obtain a brightness distribution histogram and a second brightness mean value of the second skin area based on the second mask image and the first image;
a second calculation subunit, configured to obtain a brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

As another example, the brightness adjustment curve is a power function curve, and the second calculation subunit is further configured to:
obtain the initial adjustment curve based on the difference between the first brightness mean value and the second brightness mean value;
adjust the brightness distribution histogram based on the initial adjustment curve to obtain a third brightness mean value corresponding to the second skin area;
use the initial adjustment curve as the brightness adjustment curve if a difference between the first brightness mean value and the third brightness mean value satisfies an iteration stop condition;
if the difference between the first brightness mean value and the third brightness mean value does not satisfy the iteration stop condition, update a parameter of the initial adjustment curve according to the difference between the first brightness mean value and the third brightness mean value, and return to the step of adjusting the brightness distribution histogram based on the initial adjustment curve to obtain the third brightness mean value corresponding to the second skin area and subsequent steps.

In some implementations, the adjustment unit is further configured to:
process a color of each pixel point in the first image through the brightness adjustment curve to obtain a third image;
update a corresponding pixel point in the first image with a color of a pixel point in the second skin area in the third image, and use an updated first image as the second image.

In some implementations, the calculation unit is further configured to:
obtain an average color of the first skin area based on the first mask image and the first image.

As an example, the adjustment unit is further configured to:
adjust a hue of the second skin area in the first image according to the average color of the first skin area to obtain the second image, the hue of the second skin area in the second image matching the hue of the first skin area.

In some implementations, the segmentation unit includes:
a first segmentation subunit, configured to obtain a third mask image according to the first image and a skin segmentation algorithm, the third mask image being used to indicate a third skin area of the target object in the first image, and the third skin area including the first skin area and the second skin area;
a second segmentation subunit, configured to obtain the first mask image based on a face segmentation algorithm and the first image;
a third segmentation subunit, configured to obtain the second mask image based on the third mask image and the first mask image.

As an example, the third segmentation subunit is further configured to:
eliminate the first skin area indicated by the first mask image from the third skin area indicated by the third mask image to obtain a fourth mask image, the fourth mask image being used to indicate the second skin area;
obtain a fifth mask image according to the second skin area indicated by the fourth mask image and the first skin area indicated by the first mask image, the fifth mask image being used to indicate a connection area between the first skin area and the second skin area;
perform blurring processing on the connection area indicated by the fifth mask image to obtain a sixth mask image;
fuse the sixth mask image with the fourth mask image to obtain the second mask image.

In a third aspect of the present application, an electronic device is provided, and the electronic device includes a processor and a memory, the memory is configured to store instructions or a computer program, and the processor is configured to execute the instructions or the computer program in the memory to enable the electronic device to execute the method provided in the first aspect or any implementation of the first aspect.

In a fourth aspect of the present application, a computer-readable storage medium is provided, where instructions are stored in the computer-readable storage medium, and when the instructions are run on a processor, the processor is enabled to execute the method provided in the first aspect or any implementation of the first aspect.

In a fifth aspect of the present application, a computer program product is provided, and the computer program product includes a computer program or instructions, and when the computer program or the instructions are executed by a processor, the method provided in the first aspect or any implementation of the first aspect is implemented.

In the present application, an image processing method is provided, and the method may include, for example, first, obtaining a first mask image and a second mask image corresponding to a first image, the first mask image being used to indicate a first skin area of a target object in the first image, and the second mask image being used to indicate a second skin area of the target object in the first image; then, obtaining a color adjustment parameter based on the first mask image, the second mask image and the first image; and then, adjusting a color of the second skin area of the target object in the first image according to the color adjustment parameter to obtain a second image, a color of the second skin area of the target object in the second image matching a color of the first skin area of the target object.

### BRIEF DESCRIPTION OF THE DRAWINGS

In order to more clearly describe the technical solutions in the embodiments of the present application or in the related art, the following will briefly introduce the drawings that need to be used in the description of the embodiments or the related art. Obviously, the drawings in the following description are only some embodiments recorded in the present application. For those of ordinary skill in the art, other drawings may be obtained based on these drawings without creative efforts.

FIG. 1 is a schematic flowchart of an image processing method provided by an embodiment of the present application;

FIG. 2 is a flowchart of an example of obtaining a mask image of an image provided by an embodiment of the present application;

FIG. 3 is a flowchart of an example of a determination process of a brightness adjustment curve provided by an embodiment of the present application;

FIG. 4 is a schematic structural diagram of an image processing apparatus 400 provided by an embodiment of the present application; and

FIG. 5 is a schematic structural diagram of an electronic device 500 provided by an embodiment of the present application.

### DETAILED DESCRIPTION OF EMBODIMENTS

In order for persons skilled in the art to better understand the solutions of the present application, the technical solutions in the embodiments of the present application will be described below clearly and completely with reference to the drawings in the embodiments of the present application. Apparently, the described embodiments are merely some rather than all of the embodiments of the present application. All other embodiments obtained by persons of ordinary skill in the art based on the embodiments of the present application without creative efforts shall fall within the scope of protection of the present application.

In the field of image beautification, image processing technologies are becoming increasingly mature, especially in skin processing, where a skin beautification effect is usually achieved by adjusting the brightness, hue, and evenness of the skin. At present, methods for beautifying the skin in an image generally include brightness adjustment, skin smoothing treatment, hue saturation lightness (HSL) adjustment, or red green blue (RGB) channel curve adjustment. The brightness adjustment method refers to achieving a skin whitening or brightening effect by adjusting the brightness value of an image, which may be specifically achieved through a simple linear transformation or a more complex nonlinear method (such as a logarithmic transformation method). The skin smoothing treatment method is mainly used to eliminate skin defects and unevenness, which may be specifically achieved by means of Gaussian blur, local averaging, or the like. The HSL adjustment method allows the three attributes, namely, hue, saturation, and brightness, to be controlled separately. The hue of the skin may be changed by adjusting the hue, and the vividness and brightness and darkness of the skin may be changed by adjusting the saturation and brightness. The RGB channel curve adjustment method allows the three primary colors, namely, red, green, and blue, to be controlled separately, and the performance of the primary colors may be carefully controlled by adjusting the curve of each channel. For example, raising the curve of the red channel may make the skin look more ruddy.

It may be learned through research that, taking an image including a person as an example, current image skin beautification methods usually adjust all or a part of the skin of the person in the image separately, that is, the adjustment target is only adjusted in one or more dimensions of interest without reference to other factors in the image. For example, all the skin is whitened or brightened without considering the original difference between the facial skin and the body skin, and the effect on the skin at different positions is not satisfactory after the adjustment. Possibly, the effect is excessive at some skin positions after the adjustment, and the effect is insufficient at some other skin positions after the adjustment. For another example, a part of the skin is adjusted without reference to the rest of the skin, and the effect on the skin at different positions may still be different after the adjustment. The adjustment may also make the original difference greater, making the user's perception of the processing effect worse. However, the current method for processing the skin of the person in the image cannot eliminate such differences.

In view of the difference between different skin areas in an image, an embodiment of the present application proposes an image processing method capable of comparing the difference between a plurality of skin areas, so as to eliminate the difference and make the plurality of skin areas tend to be consistent for the purpose of beautifying a target object in the image. Taking the target object being a person as an example, considering the difference between different skin areas may include, but is not limited to: firstly, the body skin and the facial skin are different in brightness and darkness. Due to the difference in the angle and intensity of light received by each part of the person, the brightness of the skin of the person in the image is unevenly distributed. In particular, compared with the facial skin, the body skin may have an obvious brightness and darkness contrast. For example, at some angles, the skin of the back or arms may appear darker, while the facial skin is relatively bright. Secondly, there is a color difference between the body skin tone and the facial skin tone. The color difference may be manifested in a case where the facial skin tone is fairer, while the skin tone of other parts of the body is relatively dark and yellow. This may be caused by a variety of factors, for example, different makeup techniques are used on the face and the body, or different makeup products are used on the face and the body. Thirdly, the body skin has defects, such as skin redness and peeling caused by sunburn, and scars such as acne marks left by acne, which will affect the smoothness of the skin and need to be beautified.

Based on this, an image processing method provided by an embodiment of the present application may include, for example, first, obtaining a first mask image and a second mask image corresponding to a first image, the first mask image being used to indicate a first skin area of a target object in the first image, and the second mask image being used to indicate a second skin area of the target object in the first image; then, obtaining a color adjustment parameter based on the first mask image, the second mask image and the first image; and then, adjusting a color of the second skin area of the target object in the first image according to the color adjustment parameter to obtain a second image, a color of the second skin area of the target object in the second image matching a color of the first skin area of the target object.

In this way, through the method, it is possible to align colors of a plurality of skin areas of a target object in an image, so as to eliminate color differences in the skin areas of the target object and improve a beautification effect of the image. That is, corresponding mask images are segmented for different skin areas of the target object in the image, the color adjustment parameter of the image is obtained based on the mask images of the different skin areas, and the color of a part of the skin areas in the image is adjusted through the color adjustment parameter, so that the color of the adjusted skin area in the adjusted image matches the color of the unadjusted skin area, thereby eliminating the difference between the different skin areas of the target object in the image, and the skin of the target object in the adjusted image meets the expectation of the user for the ideal presentation effect of the target object in the image, thereby improving the experience brought about for the user by image processing through the high-quality image beautification effect.

The color adjustment parameter may be understood as a parameter used to align a color of the second skin area with a color of the first skin area. “Aligning” the former with the latter may be considered in the embodiment of the present application as adjusting the former to match the latter, for example, adjusting the former to be consistent with the latter or meet a consistent corresponding condition with reference to the latter.

It should be noted that an entity implementing the image processing method may be an image processing apparatus provided by an embodiment of the present application. The image processing apparatus may be carried in an electronic device or a functional module of the electronic device. The image processing apparatus may be, for example, a functional module on a network device such as a server or a terminal device such as a mobile phone, for implementing an image processing function provided by the embodiment of the present application.

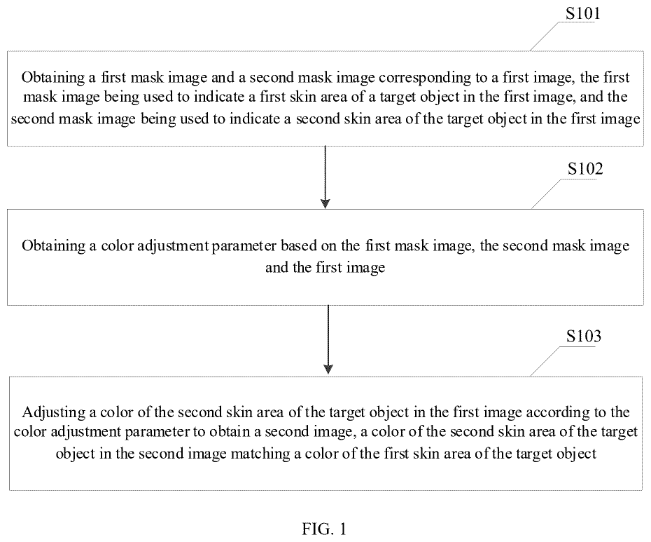

FIG. 1 is a schematic flowchart of an image processing method provided by an embodiment of the present application. The method may be applied to an image processing apparatus, and the image processing apparatus may be, for example, an image processing apparatus 400 shown in FIG. 4 below.

As shown in FIG. 1, the method may include, for example, the following steps S101 to S103.

S101, obtaining a first mask image and a second mask image corresponding to a first image, the first mask image being used to indicate a first skin area of a target object in the first image, and the second mask image being used to indicate a second skin area of the target object in the first image.

The first image is an image to be subjected to skin beautification processing. The first image includes the target object, and the target object may be, for example, an object including skin features, such as a person or an animal. The skin area of the target object in the first image may be divided into at least two different skin areas. In a specific image processing process, if the skin area of the target object is divided into two different skin areas, one of the skin areas with a better presentation effect may be used as a reference, and the presentation effect of the other skin area may be aligned with the reference. If the skin area of the target object is divided into a plurality of different skin areas, one or more skin areas with better presentation effects may be used as a reference, and the presentation effects of the other skin areas may be aligned with the reference. If a plurality of skin areas are used as the reference, the presentation effects of the plurality of skin areas used as the reference may be averaged before being referenced.

It should be noted that in this embodiment of the present application, an example in which the skin area of the target object is divided into the first skin area and the second skin area, and image processing is performed with the first skin area as reference is used for description. For the implementation and achieved effect in other cases, reference may be made to the relevant description of the method.

A mask image, which is used to indicate an area of a segmented object, may be obtained by executing a corresponding segmentation algorithm on an image to be processed.

As an example, S101 may include, for example, the following steps: S101a1, running a first segmentation algorithm on the first image to obtain the first mask image, the first segmentation algorithm being used to segment the first skin area of the target object; and S101a2, running a second segmentation algorithm on the first image to obtain the second mask image, the second segmentation algorithm being used to segment the second skin area of the target object. Taking the target object being a person, the first skin area being a facial skin area of the person, and the second skin area being a body skin area as an example, the first segmentation algorithm may be, for example, a face segmentation algorithm, and the second segmentation algorithm may be, for example, a body segmentation algorithm.

As another example, S101 may also include, for example, the following steps: S101b1, obtaining a third mask image according to the first image and a skin segmentation algorithm, the third mask image being used to indicate a third skin area of the target object in the first image, and the third skin area including the first skin area and the second skin area; S101b2, obtaining the first mask image based on a face segmentation algorithm and the first image; and S101b3, obtaining the second mask image based on the third mask image and the first mask image.

In a first case, S101b3 may include, for example, eliminating the first skin area indicated by the first mask image from the third mask image to obtain the second mask image.

In a second case, considering that the two skin areas of the target object have a connection part, direct elimination may cause a too sharp transition of the connection part, and hard-edge shadows may appear at the boundary. To solve this problem and make the transition of the connection part smoother, S101b3 may include, for example, the following steps: S11, eliminating the first skin area indicated by the first mask image from the third skin area indicated by the third mask image to obtain a fourth mask image, the fourth mask image being used to indicate the second skin area; S12, obtaining a fifth mask image according to the second skin area indicated by the fourth mask image and the first skin area indicated by the first mask image, the fifth mask image being used to indicate a connection area between the first skin area and the second skin area; S13, performing blurring processing on the connection area indicated by the fifth mask image to obtain a sixth mask image; and S14, fusing the sixth mask image with the fourth mask image to obtain the second mask image. The blurring processing method in S13 may be, for example, a Gaussian blur algorithm. In this way, by performing blurring processing on the connection area between the two skin areas and fusing the mask image corresponding to the processed connection area with at least one area before the processing, the transition between the two skin areas is ensured to be smoother and softer.

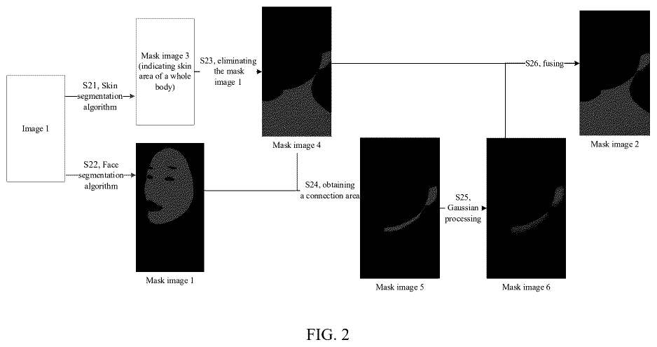

Taking the target object being a person, the first skin area being a facial skin area of the person, and the second skin area being a body skin area as an example, for an execution process of S101 in this example, reference may be made to, for example, FIG. 2. As shown in FIG. 2, S101 may include: S21, inputting an image 1 into the skin segmentation algorithm in S101b1, and outputting a mask image 3, the mask image 3 indicating a skin area of the whole body of the person; S22, inputting the image 1 into the face segmentation algorithm in S101b2, and outputting a mask image 1, the mask image 1 indicating a facial skin area; S23, eliminating the skin area indicated by the mask image 1 in the mask image 3 to obtain a mask image 4, the mask image 4 indicating a body skin area; S24, extracting a connection area between the mask image 1 and the mask image 4 to obtain a corresponding mask image 5, the mask image 5 indicating a skin area including a neck; S25, performing Gaussian blur processing on the mask image 5 to obtain a mask image 6; and S26, fusing the mask image 6 with the mask image 4 to obtain a mask image 2, a boundary of the body skin area indicated by the mask image 2 being softer than a boundary of the body skin area indicated by the mask image 4. Optionally, the mask image 6 may also be fused with the mask image 1 to obtain a mask image 1′, and a boundary of the facial skin area indicated by the mask image 1′ is softer than a boundary of the facial skin area indicated by the mask image 1.

It should be noted that in the mask image, in order to accurately express the skin attribute of the indicated skin area, details of the obtained mask image may also be adjusted to update the corresponding mask image in S101. For example, in the scenario shown in FIG. 2, a part of the face that may interfere with skin adjustment may be eliminated, for example, parts such as eyes, eyebrows, mouth and teeth indicated in the mask image output from the face segmentation algorithm are excluded from the facial skin area, and the value of the alpha channel of the corresponding pixel point is set to 0 to obtain the mask image 1 shown in FIG. 2.

It may be seen that the mask images corresponding to different skin areas of the target object are obtained through S101, which provides a basis for subsequently determining the color adjustment parameter capable of eliminating the color difference between the different skin areas.

S102, obtaining a color adjustment parameter based on the first mask image, the second mask image and the first image.

In this embodiment of the present application, colors of the skin areas may be aligned in at least one of two dimensions of brightness and hue. The color adjustment parameter may include a brightness adjustment curve and/or a hue adjustment parameter, the brightness adjustment curve is used to align brightness of the second skin area with brightness of the first skin area, and the hue adjustment parameter is used to align a hue of the second skin area with a hue of the first skin area.

For the adjustment in the brightness dimension, S102 may refer to obtaining the brightness adjustment curve based on the first mask image, the second mask image and the first image, and the process may include: S1021, obtaining a first brightness mean value of the first skin area based on the first mask image and the first image, and obtaining a brightness distribution histogram and a second brightness mean value of the second skin area based on the second mask image and the first image; and S1022, obtaining the brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

As an example, a manner of obtaining the first brightness mean value in S1021 may be: converting a RGB channel of an area corresponding to the first skin area indicated in the first mask image in the first image into a single-channel gray scale image 1, where a gray-scale value of each pixel point represents brightness of the current pixel point; obtaining a brightness distribution histogram 1 corresponding to the first skin area based on the gray scale image 1, the brightness distribution histogram 1 indicating a number of pixel points corresponding to each brightness value (or a ratio of the pixel points corresponding to each brightness value to a total number of pixel points); and calculating the first brightness mean value of the first skin area based on the brightness distribution histogram 1. For example, the brightness distribution histogram 1 includes 10000 pixel points, there are 8000 pixel points with brightness of 200, and 2000 pixel points with brightness of 128. Since a brightness value range of the pixel points in the gray scale image is 1 to 255, the first brightness mean value=(200/255)*(8000/10000)+(128/255)*(2000/10000)≈0.72. A manner of obtaining the second brightness mean value in S1021 is similar.

The brightness adjustment curve may be in a type of power function curve, spline curve, Bezier curve, or the like. Taking the brightness adjustment curve being in the type of power function curve as an example, S1022 may include, for example, the following steps: S31, obtaining the initial adjustment curve based on the difference between the first brightness mean value and the second brightness mean value; S32, adjusting the brightness distribution histogram based on the initial adjustment curve to obtain a third brightness mean value corresponding to the second skin area; S33, determining whether a difference between the first brightness mean value and the third brightness mean value satisfies an iteration stop condition, if yes, executing S34, otherwise, executing S35; S34, using the initial adjustment curve as the brightness adjustment curve; and S35, updating a parameter of the initial adjustment curve according to the difference between the first brightness mean value and the third brightness mean value, and returning to S32.

The iteration stop condition may be a preset condition used to indicate that the iteration process is stopped and the current initial adjustment curve is used as the brightness adjustment curve. For example, the iteration stop condition may include: a number of iterations reaching a preset number threshold, and/or the difference between the first brightness mean value and the third brightness mean value being less than or equal to a preset difference threshold.

For an expression of the power function curve, see the following formula (1):

$$y = 1 - {( 1 - x )}^{p} \qquad formula ( 1 )$$

where x is a number between 0 and 1, and p is a brightness adjustment parameter. Obtaining the brightness adjustment curve in S102 may essentially be considered as determining p in formula (1) to obtain a determined power function curve. First, determining the initial adjustment curve based on the difference between the first brightness mean value and the second brightness mean value may be determining an initial value of p according to the difference between the first brightness mean value and the second brightness mean value and based on experience or experiment. A reasonable degree of the initial value of p determines a speed of iteration convergence, that is, the more reasonable the initial value of p, the faster the final value of p may be determined.

It is assumed that the initial value of p determined based on the difference between the first brightness mean value and the second brightness mean value is 2, then the formula for the first iteration is the following formula (2):

$$y = 1 - {( 1 - x )}^{2} \qquad formula ( 2 )$$

In the initial brightness distribution histogram of the second skin area, each brightness value may be taken as x in formula (2) to calculate the corresponding y as the brightness corresponding to the second skin area after the first iteration. Thus, the third brightness mean value of the second skin area after the first iteration is calculated based on the brightness of the second skin area after the first iteration. Then, it is determined, based on the difference between the first brightness mean value and the third brightness mean value, whether p should be increased or decreased and an adjustment amplitude. For example, it is determined that p is adjusted to 3, then the formula for the second iteration is the following formula (3):

$$y = 1 - {( 1 - x )}^{3} \qquad formula ( 3 )$$

In the brightness distribution histogram of the second skin area after the first iteration, each brightness value may be taken as x in formula (3) to calculate the corresponding y as the brightness corresponding to the second skin area after the second iteration. Thus, the third brightness mean value of the second skin area after the second iteration is calculated based on the brightness of the second skin area after the second iteration. Then, it is determined, based on the difference between the first brightness mean value and the third brightness mean value, whether p should be increased or decreased and the adjustment amplitude. This is repeated until the iteration stop condition is reached, and the formula at this time is used as the brightness adjustment curve to participate in the adjustment in S103. The adjustment in the brightness dimension may be understood as an adjustment of the color brightness and darkness of the skin area.

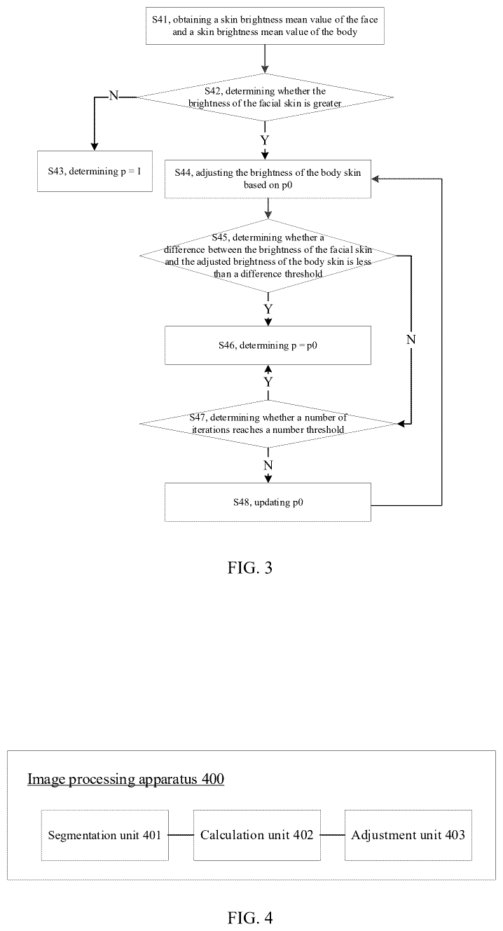

As an example, as shown in FIG. 3, taking the target object being a person, the first skin area corresponding to the facial skin area, and the second skin area corresponding to the body skin area as an example, the process of obtaining p in the power function curve may include: S41, obtaining a skin brightness mean value of the face and a skin brightness mean value of the body; S42, determining whether the brightness of the facial skin is greater, if yes, executing S44 to S48, otherwise, executing S43; S43, determining p=1, that is, not adjusting the brightness of the body skin; S44, adjusting the brightness of the body skin based on p0; S45, determining whether a difference between the brightness of the facial skin and the adjusted brightness of the body skin is less than a difference threshold, if yes, executing S46, if no, executing S47; S46, determining p=p0; S47, determining whether a number of iterations reaches a number threshold, if yes, executing S46, if no, executing S48; and S48, updating p0, and returning to S44.

For the adjustment in the hue dimension, S102 may refer to obtaining the hue adjustment parameter based on the first mask image, the second mask image and the first image. The process may include: obtaining the average color of the first skin area based on the first mask image and the first image. It may be understood that an average value of pixel points on the first skin area indicated in the first mask image in the first image is calculated on each of the three RGB channels to obtain the average color Average(r,g,b) of the first skin area. The manner of calculating the average value may be implemented based on the following formula (4) to formula (6):

$${Average}_{R} = \frac{{\sum }_{i = 0}^{H - 1} {\sum }_{j = 0}^{W - 1} R ( i , j )}{W \times H} \qquad formula ( 4 )$$

$${Average}_{G} = \frac{{\sum }_{i = 0}^{H - 1} {\sum }_{j = 0}^{W - 1} G ( i , j )}{W \times H} \qquad formula ( 5 )$$

$${Average}_{B} = \frac{{\sum }_{i = 0}^{H - 1} {\sum }_{j = 0}^{W - 1} B ( i , j )}{W \times H} \qquad formula ( 6 )$$

It may be understood that the pixel points of the first skin area are arranged into a matrix of W*H, (i, j) refers to a position of a pixel point in the matrix of W*H, R(i, j) is a value of the pixel point at the position (i, j) on the R channel, Average_{R} refers to an average value of the first skin area on the R channel, G(i, j) is a value of the pixel point at the position (i, j) on the G channel, Average_{G} refers to an average value of the first skin area on the G channel, B(i, j) is a value of the pixel point at the position (i, j) on the B channel, and Average_{B} refers to an average value of the first skin area on the B channel. The above Average_{R}, Average_{G}, and Average_{B} are used as the hue adjustment parameter to participate in the adjustment in S103. The adjustment in the hue dimension may be understood as an adjustment of the color depth of the skin area.

The color adjustment parameter calculated in S102 may be used as an input for the adjustment in S103, which makes it possible to obtain the second image with a better presentation effect through the adjustment.

S103, adjusting a color of the second skin area of the target object in the first image according to the color adjustment parameter to obtain a second image, the color of the second skin area of the target object in the second image matching the color of the first skin area of the target object.

It should be noted that in one case, the method provided in this embodiment of the present application may all be implemented by a graphics processing unit (GPU); in another case, a part of the steps may be implemented by the GPU, and a part of the steps may be implemented by a central processing unit (CPU). For example, S101 to S102 are implemented by the CPU, and S103 is implemented by the GPU.

For the case where the color adjustment parameter includes the brightness adjustment curve, considering that the GPU has a fast execution speed for batch tasks, pre-filtering the batch tasks and then processing the filtering results may affect the execution speed of the GPU, which is not friendly to the efficient task processing of the GPU. Therefore, S103 may include, for example, the following steps: S1031, processing a color of each pixel point in the first image through the brightness adjustment curve to obtain a third image; and S1032, updating a corresponding pixel point in the first image with a color of a pixel point in the second skin area in the third image, and using an updated first image as the second image. In this way, efficient and high-quality skin adjustment is achieved in the brightness dimension.

In another implementation, S103 may also include: processing a color of a pixel point in the second skin area of the target object in the first image through the brightness adjustment curve without adjusting other pixel points in the first image to obtain an updated first image, and using the updated first image as a result of this image processing, that is, recording the updated first image as the second image. In this way, high-quality skin adjustment is achieved in the brightness dimension.

For the case where the color adjustment parameter includes the hue adjustment parameter, S103 may include, for example, adjusting a hue of the second skin area in the first image according to the average color of the first skin area to obtain the second image, the hue of the second skin area in the second image being aligned with the hue of the first skin area. As an example, S103 may be implemented through an existing “color” blending mode in some image processing clients, for example, using a function corresponding to the “color” blending mode. An input of the function includes the average color of the first skin area and the first image (that is, the color of each pixel point in the first image), and an output of the function is the second image. In this way, high-quality skin adjustment is achieved in the hue dimension.

It should be noted that for the case where the color adjustment parameter includes the brightness adjustment curve and the hue adjustment parameter, S103 may include, for example, the following steps: processing the color of each pixel point in the first image through the brightness adjustment curve to obtain the third image; updating the corresponding pixel point in the first image with the color of the pixel point in the second skin area in the third image; and adjusting the hue of the second skin area in the updated first image according to the average color of the first skin area to obtain the second image. In this way, high-quality adjustment of the skin color is achieved in both dimensions of brightness and hue.

In some possible implementations, a corresponding mixing factor may also be set for each pixel point in the second image based on the second mask image, and the mixing factor may be a value between 0 and 1. The value of the mixing factor is used to characterize an intensity of a body skin attribute of the corresponding pixel point. The greater the value of the mixing factor, the stronger the body skin attribute of the corresponding pixel point. On the contrary, the smaller the value of the mixing factor, the weaker the body skin attribute of the corresponding pixel point. For example, in the case where the target object is a person, the pixel points in the body skin area have a larger mixing factor, and the pixel points in other parts (such as the face, hair, clothes, background, etc.) have a smaller mixing factor. The function of the mixing factor may be understood as a means to implement S1032 and related steps, that is, for the pixel point with a large mixing factor in the third image, a value is taken from the third image, and for the pixel point with a small mixing factor in the third image, a value is taken from the first image. Thus, “updating the corresponding pixel point in the first image with the color of the pixel point in the second skin area in the third image” is achieved.

It should be noted that in order to be able to more flexibly decide an intensity of beautifying the body skin and improve the experience of the user when using this function, a slider parameter may also be set, and the slider parameter is used to determine a degree of skin alignment.

For example, in the case where the color adjustment parameter includes only the hue adjustment parameter, a value of each pixel point in the first image and a value of each pixel point in the second image may first be mixed based on the slider parameter to obtain a first processing result. If the slider parameter=1, the first processing result is the second image. If the slider parameter=0, the first processing result is the first image. The greater the slider parameter, the closer the first processing result is to the second image. Then, the first image and the first processing result are mixed based on the mixing factor to obtain a second processing result, that is, the final result of this image processing. For the pixel point with the mixing factor=1, a value corresponding to the second processing result is obtained from the first processing result. For the pixel point with the mixing factor=0, the value corresponding to the second processing result is obtained from the first image. For a pixel point with a larger mixing factor, the value corresponding to the second processing result is closer to a corresponding value in the first processing result. In this way, flexible and efficient skin beautification is achieved.

For another example, in the case where the color adjustment parameter includes the brightness adjustment curve and the hue adjustment parameter, a value of each pixel point in the third image and a value of each pixel point in the second image may first be mixed based on the slider parameter to obtain a third processing result. If the slider parameter=1, the third processing result is the second image. If the slider parameter=0, the third processing result is the third image. The greater the slider parameter, the closer the first processing result is to the second image. Then, the first image and the third processing result are mixed based on the mixing factor to obtain a fourth processing result, that is, the final result of this image processing. For the pixel point with the mixing factor=1, a value corresponding to the fourth processing result is obtained from the third processing result. For the pixel point with the mixing factor=0, the value corresponding to the fourth processing result is obtained from the first image. For a pixel point with a larger mixing factor, the value corresponding to the fourth processing result is closer to a corresponding value in the third processing result. In this way, flexible, efficient and high-quality skin beautification is achieved.

It may be seen that, through the method, corresponding mask images are segmented for different skin areas of the target object in the image, the color adjustment parameter of the image is obtained based on the mask images of the different skin areas, and the color of a part of the skin areas in the image is adjusted through the color adjustment parameter, so that the color of the adjusted skin area in the adjusted image matches the color of the unadjusted skin area, thereby eliminating the difference between the different skin areas of the target object in the image, and the skin of the target object in the adjusted image meets the expectation of the user for the ideal presentation effect of the target object in the image, thereby improving the experience brought about for the user by image processing through the high-quality image beautification effect.

It should be noted that in the case where the target object is a person, the first skin area is a face skin area, and the second skin area is a body skin area, the method achieves the processing of aligning a body color with a face color, and quickly and effectively solves the problems of inconsistency between the face and the body of the person in the image and sunburn marks on the body part, so that the processed image meets the user's expectation for the effect of solving the problem of the difference between the body and the face skin that the user is concerned about.

In some other scenarios, it is also possible to align a color of the face skin with a color of the body skin according to a requirement. Alternatively, the skin of the person may be divided into more areas according to a requirement. In one case, a skin color of one or more areas is used as a reference, and one or more other areas are aligned with the reference. Alternatively, in another case, skin colors of a plurality of areas are respectively used as different references, and a plurality of other areas are aligned with corresponding references according to requirements. The image processing in the above scenarios may all be implemented based on the method provided in the embodiment of the present application.

Correspondingly, an embodiment of the present application further provides an image processing apparatus 400, as shown in FIG. 4. The apparatus 400 may include:
a segmentation unit 401, configured to obtain a first mask image and a second mask image corresponding to a first image, the first mask image being used to indicate a first skin area of a target object in the first image, and the second mask image being used to indicate a second skin area of the target object in the first image;
a calculation unit 402, configured to obtain a color adjustment parameter based on the first mask image, the second mask image and the first image;
an adjustment unit 403, configured to adjust a color of the second skin area of the target object in the first image according to the color adjustment parameter to obtain a second image, a color of the second skin area of the target object in the second image matching a color of the first skin area of the target object.

In some implementations, the color adjustment parameter includes a brightness adjustment curve and/or a hue adjustment parameter, the brightness adjustment curve is used to adjust brightness of the second skin area to match brightness of the first skin area, and the hue adjustment parameter is used to adjust a hue of the second skin area to match a hue of the first skin area.

As an example, the calculation unit 402 includes:
a first calculation subunit, configured to obtain a first brightness mean value of the first skin area based on the first mask image and the first image, and obtain a brightness distribution histogram and a second brightness mean value of the second skin area based on the second mask image and the first image; and
a second calculation subunit, configured to obtain a brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

As another example, the brightness adjustment curve is a power function curve, and the second calculation subunit is further configured to:
obtain the initial adjustment curve based on the difference between the first brightness mean value and the second brightness mean value;
adjust the brightness distribution histogram based on the initial adjustment curve to obtain a third brightness mean value corresponding to the second skin area;
use the initial adjustment curve as the brightness adjustment curve if a difference between the first brightness mean value and the third brightness mean value satisfies an iteration stop condition;
if the difference between the first brightness mean value and the third brightness mean value does not satisfy the iteration stop condition, update a parameter of the initial adjustment curve according to the difference between the first brightness mean value and the third brightness mean value, and return to the step of adjusting the brightness distribution histogram based on the initial adjustment curve to obtain the third brightness mean value corresponding to the second skin area and subsequent steps.

In some implementations, the adjustment unit 403 is further configured to:
process a color of each pixel point in the first image through the brightness adjustment curve to obtain a third image;
update a corresponding pixel point in the first image with a color of a pixel point in the second skin area in the third image, and use an updated first image as the second image.

In some implementations, the calculation unit 402 is further configured to:
obtain an average color of the first skin area based on the first mask image and the first image.

As an example, the adjustment unit 403 is further configured to:
adjust a hue of the second skin area in the first image according to the average color of the first skin area to obtain the second image, the hue of the second skin area in the second image matching the hue of the first skin area.

In some implementations, the segmentation unit 401 includes:
a first segmentation subunit, configured to obtain a third mask image according to the first image and a skin segmentation algorithm, the third mask image being used to indicate a third skin area of the target object in the first image, and the third skin area including the first skin area and the second skin area;
a second segmentation subunit, configured to obtain the first mask image based on a face segmentation algorithm and the first image;
a third segmentation subunit, configured to obtain the second mask image based on the third mask image and the first mask image.

As an example, the third segmentation subunit is further configured to:
eliminate the first skin area indicated by the first mask image from the third skin area indicated by the third mask image to obtain a fourth mask image, the fourth mask image being used to indicate the second skin area;
obtain a fifth mask image according to the second skin area indicated by the fourth mask image and the first skin area indicated by the first mask image, the fifth mask image being used to indicate a connection area between the first skin area and the second skin area;
perform blurring processing on the connection area indicated by the fifth mask image to obtain a sixth mask image;
fuse the sixth mask image with the fourth mask image to obtain the second mask image.

It should be noted that for the specific implementation of the apparatus 400 and the technical effect achieved, reference may be made to the relevant description of the method shown in the embodiment of the present application.

In addition, an embodiment of the present application further provides an electronic device, and the electronic device includes a processor and a memory, the memory is configured to store instructions or a computer program, and the processor is configured to execute the instructions or the computer program in the memory to enable the electronic device to execute any implementation of the method provided in the embodiment of the present application.

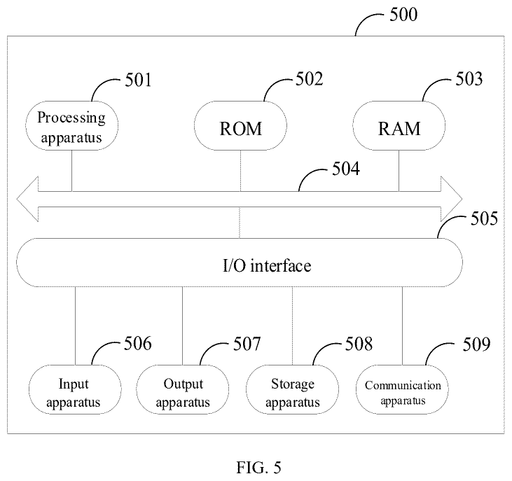

Referring to FIG. 5, FIG. 5 shows a schematic diagram of a structure of an electronic device 500 suitable for implementing an embodiment of the present disclosure. The terminal device in the embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), a vehicle-mounted terminal (such as a vehicle-mounted navigation terminal), etc., and fixed terminals such as a digital TV, a desktop computer, etc. The electronic device shown in FIG. 5 is only an example, and should not impose any limitation on the function and scope of use of the embodiment of the present disclosure.

As shown in FIG. 5, the electronic device 500 may include a processing apparatus (e.g., a central processing unit, a graphics processing unit, etc.) 501 that may perform various appropriate actions and processes according to a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Typically, the following apparatus may be connected to the I/O interface 505: an input apparatus 506 including, for example, a touch screen, a touchpad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a magnetic tape, a hard disk, etc.; and a communication apparatus 509. The communication apparatus 509 may allow the electronic device 500 to perform wireless or wired communication with other devices to exchange data. While FIG. 5 shows the electronic device 500 having various apparatuses, it should be understood that not all of the illustrated apparatuses are necessarily implemented or included. Alternatively, more or fewer apparatuses may be implemented or provided.

In particular, according to the embodiments of the present disclosure, the processes described above with reference to the flowcharts may be implemented as computer software programs. For example, the embodiments of the present disclosure include a computer program product including a computer program carried on a non-transitory computer-readable medium, the computer program containing program code for performing the method shown in the flowchart. In such an embodiment, the computer program may be downloaded and installed from a network via the communication apparatus 509, or installed from the storage apparatus 508, or installed from the ROM 502. When the computer program is executed by the processing apparatus 501, the aforementioned functions defined in the method of the embodiments of the present disclosure are executed.

The electronic device provided by the embodiments of the present disclosure belongs to the same inventive concept as the method provided by the above embodiments, and for technical details not described in detail in this embodiment, reference may be made to the above embodiments, and this embodiment has the same beneficial effects as the above embodiments.

An embodiment of the present application further provides a computer-readable medium, where instructions or a computer program is stored in the computer-readable medium, and when the instruction or the computer program is run on a device, the device is enabled to execute any implementation of the method provided in the embodiment of the present application.

It should be noted that the above computer-readable medium in the present disclosure may be a computer-readable signal medium, a computer-readable storage medium, or any combination thereof. The computer-readable storage medium may be, for example, but not limited to, an electronic, magnetic, optical, electromagnetic, infrared, or semiconductor system, apparatus or device, or any suitable combination of the above. More specific examples of the computer-readable storage medium may include, but are not limited to: an electrically connected portable computer disk having one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier wave, and computer-readable program code is carried in the data signal. The data signal propagated in this way may be in multiple forms, and includes, but is not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus or device. The program code contained on the computer-readable medium may be transmitted by any suitable medium, including, but not limited to: a wire, an optical cable, a radio frequency (RF), etc., or any suitable combination of the above.

The above computer-readable medium may be contained in the above electronic device, or may exist alone without being assembled into the electronic device.

The above computer-readable medium carries one or more programs, and when the one or more programs are executed by the electronic device, the electronic device is enabled to execute the above method.

Computer program code for performing the operations of the present disclosure may be written in one or more programming languages or a combination thereof. The above programming languages include, but are not limited to, object-oriented programming languages such as Java, Smalltalk, and C++, and further include conventional procedural programming languages such as “C” language or similar programming languages. The program code may be completely executed on a user computer, partially executed on a user computer, executed as an independent software package, partially executed on a user computer and partially executed on a remote computer, or completely executed on a remote computer or a server. In the case of involving a remote computer, the remote computer may be connected to the user computer through any kind of network, including a local area network (LAN) or a wide area network (WAN), or may be connected to an external computer (for example, connected through the Internet with the aid of an Internet service provider).

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, functions noted in the block may occur in an order different from that noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The involved units described in the embodiments of the present disclosure may be implemented by means of software, and may also be implemented by means of hardware. The name of a unit/module does not constitute a limitation on the unit itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination of the above. More specific examples of the machine-readable storage medium will include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the embodiments in this specification are described in a progressive manner, and each embodiment focuses on the differences from other embodiments. For the same and similar parts between the embodiments, reference may be made to each other. For the system or apparatus disclosed in the embodiments, since it corresponds to the method disclosed in the embodiments, the description is relatively simple, and for the related parts, reference may be made to the description of the method.

It should be understood that in the present application, “at least one (item)” means one or more, and “a plurality of” means two or more. “And/or” describes an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects. “At least one of the following items (pieces)” or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should also be noted that in this paper, relational terms such as first and second are used only to distinguish one entity or operation from another entity or operation, and do not necessarily require or imply any actual relationship or order between these entities or operations. Moreover, the terms “include”, “include”, or any other variant thereof are intended to cover non-exclusive inclusion, so that a process, method, object, or device including a series of elements includes not only those elements, but also other elements not explicitly listed or elements intrinsic to such process, method, object, or device. Without further restrictions, an element defined by the phrase “including a” does not exclude that there are other identical elements in the process, method, object, or device that includes the element.

Steps of a method or an algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

It should be noted that the embodiments of the present application do not involve sensitive information of a user, and even if the related information of the user is used, the related information of the user is acquired, used, and determined after obtaining the authorization of the user.

The foregoing descriptions of the disclosed embodiments enable those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. An image processing method, comprising:
obtaining a first mask image and a second mask image corresponding to a first image, the first mask image being configured to indicate a first skin area of an object in the first image, and the second mask image being configured to indicate a second skin area of the object in the first image;
obtaining a color adjustment parameter based on the first mask image, the second mask image and the first image;
adjusting a color of the second skin area of the object in the first image according to the color adjustment parameter to obtain a second image, a color of the second skin area of the object in the second image matching a color of the first skin area of the object.

2. The method of claim 1, wherein the color adjustment parameter comprises at least one of a brightness adjustment curve or a hue adjustment parameter, the brightness adjustment curve is configured to adjust brightness of the second skin area to match brightness of the first skin area, and the hue adjustment parameter is configured to adjust a hue of the second skin area to match a hue of the first skin area.

3. The method of claim 2, wherein the obtaining the brightness adjustment curve based on the first mask image, the second mask image and the first image comprises:
obtaining a first brightness mean value of the first skin area based on the first mask image and the first image, and obtaining a brightness distribution histogram and a second brightness mean value of the second skin area based on the second mask image and the first image;
obtaining the brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

4. The method of claim 3, wherein the brightness adjustment curve is a power function curve, and the obtaining the brightness adjustment curve based on the difference between the first brightness mean value and the second brightness mean value, the brightness distribution histogram, and the initial adjustment curve comprises:
obtaining the initial adjustment curve based on the difference between the first brightness mean value and the second brightness mean value;
adjusting the brightness distribution histogram based on the initial adjustment curve to obtain a third brightness mean value corresponding to the second skin area;
using the initial adjustment curve as the brightness adjustment curve, if a difference between the first brightness mean value and the third brightness mean value satisfies an iteration stop condition;
updating a parameter of the initial adjustment curve according to the difference between the first brightness mean value and the third brightness mean value, if the difference between the first brightness mean value and the third brightness mean value does not satisfy the iteration stop condition, and repeating the step of adjusting the brightness distribution histogram based on the initial adjustment curve to obtain the third brightness mean value corresponding to the second skin area until the difference between the first brightness mean value and the third brightness mean value satisfies the iteration stop condition.

5. The method of claim 3, wherein the adjusting the color of the second skin area of the object in the first image according to the color adjustment parameter to obtain the second image comprises:
processing a color of each pixel point in the first image through the brightness adjustment curve to obtain a third image;
updating a corresponding pixel point in the first image with a color of a pixel point in the second skin area in the third image, and using an updated first image as the second image.

6. The method of claim 2, wherein the obtaining the hue adjustment parameter based on the first mask image, the second mask image and the first image comprises:
obtaining an average color of the first skin area based on the first mask image and the first image.

7. The method of claim 6, wherein the adjusting the color of the second skin area of the object in the first image according to the color adjustment parameter to obtain the second image comprises:
adjusting a hue of the second skin area in the first image according to the average color of the first skin area to obtain the second image, the hue of the second skin area in the second image matching the hue of the first skin area.

8. The method of claim 1, wherein the obtaining the first mask image and the second mask image corresponding to the first image comprises:
obtaining a third mask image according to the first image and a skin segmentation algorithm, the third mask image being configured to indicate a third skin area of the object in the first image, and the third skin area comprising the first skin area and the second skin area;
obtaining the first mask image based on a face segmentation algorithm and the first image;
obtaining the second mask image based on the third mask image and the first mask image.

9. The method of claim 8, wherein the obtaining the second mask image based on the third mask image and the first mask image comprises:
eliminating the first skin area indicated by the first mask image from the third skin area indicated by the third mask image to obtain a fourth mask image, the fourth mask image being configured to indicate the second skin area;
obtaining a fifth mask image according to the second skin area indicated by the fourth mask image and the first skin area indicated by the first mask image, the fifth mask image being configured to indicate a connection area between the first skin area and the second skin area;
performing blurring processing on the connection area indicated by the fifth mask image to obtain a sixth mask image;
fusing the sixth mask image with the fourth mask image to obtain the second mask image.

10. An electronic device, wherein the electronic device comprises a processor and a memory;
the memory is configured to store instructions or a computer program;
the processor is configured to execute the instructions or the computer program in the memory to cause the electronic device to execute an image processing method, comprising:
obtaining a first mask image and a second mask image corresponding to a first image, the first mask image being configured to indicate a first skin area of an object in the first image, and the second mask image being configured to indicate a second skin area of the object in the first image;
obtaining a color adjustment parameter based on the first mask image, the second mask image and the first image;
adjusting a color of the second skin area of the object in the first image according to the color adjustment parameter to obtain a second image, a color of the second skin area of the object in the second image matching a color of the first skin area of the object.

11. The electronic device of claim 10, wherein the color adjustment parameter comprises at least one of a brightness adjustment curve or a hue adjustment parameter, the brightness adjustment curve is configured to adjust brightness of the second skin area to match brightness of the first skin area, and the hue adjustment parameter is configured to adjust a hue of the second skin area to match a hue of the first skin area.

12. The electronic device of claim 11, wherein the obtaining the brightness adjustment curve based on the first mask image, the second mask image and the first image comprises:
obtaining a first brightness mean value of the first skin area based on the first mask image and the first image, and obtaining a brightness distribution histogram and a second brightness mean value of the second skin area based on the second mask image and the first image;
obtaining the brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

13. The electronic device of claim 12, wherein the brightness adjustment curve is a power function curve, and the obtaining the brightness adjustment curve based on the difference between the first brightness mean value and the second brightness mean value, the brightness distribution histogram, and the initial adjustment curve comprises:
obtaining the initial adjustment curve based on the difference between the first brightness mean value and the second brightness mean value;
adjusting the brightness distribution histogram based on the initial adjustment curve to obtain a third brightness mean value corresponding to the second skin area;
using the initial adjustment curve as the brightness adjustment curve, if a difference between the first brightness mean value and the third brightness mean value satisfies an iteration stop condition;
updating a parameter of the initial adjustment curve according to the difference between the first brightness mean value and the third brightness mean value, if the difference between the first brightness mean value and the third brightness mean value does not satisfy the iteration stop condition, and repeating the step of adjusting the brightness distribution histogram based on the initial adjustment curve to obtain the third brightness mean value corresponding to the second skin area until the difference between the first brightness mean value and the third brightness mean value satisfies the iteration stop condition.

14. The electronic device of claim 12, wherein the adjusting the color of the second skin area of the object in the first image according to the color adjustment parameter to obtain the second image comprises:
processing a color of each pixel point in the first image through the brightness adjustment curve to obtain a third image;
updating a corresponding pixel point in the first image with a color of a pixel point in the second skin area in the third image, and using an updated first image as the second image.

15. The electronic device of claim 11, wherein the obtaining the hue adjustment parameter based on the first mask image, the second mask image and the first image comprises:
obtaining an average color of the first skin area based on the first mask image and the first image.

16. A non-transitory computer-readable storage medium, wherein instructions are stored in the computer-readable storage medium, and when the instructions are run on a processor, the processor is caused to execute an image processing method, comprising:
obtaining a first mask image and a second mask image corresponding to a first image, the first mask image being configured to indicate a first skin area of an object in the first image, and the second mask image being configured to indicate a second skin area of the object in the first image;
obtaining a color adjustment parameter based on the first mask image, the second mask image and the first image;
adjusting a color of the second skin area of the object in the first image according to the color adjustment parameter to obtain a second image, a color of the second skin area of the object in the second image matching a color of the first skin area of the object.

17. The non-transitory computer-readable storage medium of claim 16, wherein the color adjustment parameter comprises at least one of a brightness adjustment curve or a hue adjustment parameter, the brightness adjustment curve is configured to adjust brightness of the second skin area to match brightness of the first skin area, and the hue adjustment parameter is configured to adjust a hue of the second skin area to match a hue of the first skin area.

18. The non-transitory computer-readable storage medium of claim 17, wherein the obtaining the brightness adjustment curve based on the first mask image, the second mask image and the first image comprises:
obtaining a first brightness mean value of the first skin area based on the first mask image and the first image, and obtaining a brightness distribution histogram and a second brightness mean value of the second skin area based on the second mask image and the first image;
obtaining the brightness adjustment curve based on a difference between the first brightness mean value and the second brightness mean value, the brightness distribution histogram, and an initial adjustment curve, the initial adjustment curve being determined based on the difference between the first brightness mean value and the second brightness mean value.

19. The non-transitory computer-readable storage medium of claim 18, wherein the brightness adjustment curve is a power function curve, and the obtaining the brightness adjustment curve based on the difference between the first brightness mean value and the second brightness mean value, the brightness distribution histogram, and the initial adjustment curve comprises:
obtaining the initial adjustment curve based on the difference between the first brightness mean value and the second brightness mean value;
adjusting the brightness distribution histogram based on the initial adjustment curve to obtain a third brightness mean value corresponding to the second skin area;
using the initial adjustment curve as the brightness adjustment curve, if a difference between the first brightness mean value and the third brightness mean value satisfies an iteration stop condition;
updating a parameter of the initial adjustment curve according to the difference between the first brightness mean value and the third brightness mean value, if the difference between the first brightness mean value and the third brightness mean value does not satisfy the iteration stop condition, and repeating the step of adjusting the brightness distribution histogram based on the initial adjustment curve to obtain the third brightness mean value corresponding to the second skin area until the difference between the first brightness mean value and the third brightness mean value satisfies the iteration stop condition.

20. The non-transitory computer-readable storage medium of claim 18, wherein the adjusting the color of the second skin area of the object in the first image according to the color adjustment parameter to obtain the second image comprises:
processing a color of each pixel point in the first image through the brightness adjustment curve to obtain a third image;
updating a corresponding pixel point in the first image with a color of a pixel point in the second skin area in the third image, and using an updated first image as the second image.
